(19) United States
(12) Patent Application Publication
(10) Pub. No.: US 2025/0257493 A1
(43) Pub. Date: Aug. 14, 2025

(54) ELECTROFORMING PLATE, METHOD OF MANUFACTURING ELECTROFORMING PLATE, METAL MOLDED ARTICLE MANUFACTURING METHOD

(71) Applicant: FUJIFILM Corporation, Tokyo (JP)

(72) Inventors: Tomokazu UMEZAWA, Kanagawa (JP); Kozue IKEDA, Kanagawa (JP)

(73) Assignee: FUJIFILM Corporation, Tokyo (JP)

(21) Appl. No.: 19/049,997

(22) Filed: Feb. 10, 2025

(30) Foreign Application Priority Data
Feb. 14, 2024 (JP) 2024-020160

(51) Int. Cl. C25D 1/10

(52) U.S. Cl. CPC C25D 1/10

(57) ABSTRACT

In the electroforming plate, the method of manufacturing an electroforming plate, and the metal molded article manufacturing method, the electroforming plate includes a semiconductor substrate and an insulating mask provided at a part of a surface of the semiconductor substrate, in which the insulating mask is composed of an insulating layer formed by an insulating treatment on the surface of the semiconductor substrate, at the surface of the semiconductor substrate, a portion where the insulating mask is not provided is an alloy layer containing a constituent element of the semiconductor substrate and a metal element diffused into the semiconductor substrate, and the insulating mask protrudes from a surface of the alloy layer.

### CROSS REFERENCE TO RELATED APPLICATIONS

This application claims priority from Japanese Application No. 2024-020160, filed on Feb. 14, 2024, the entire disclosure of which is incorporated herein by reference.

### BACKGROUND

### 1. Technical Field

The present disclosure relates to an electroforming plate, a method of manufacturing an electroforming plate, and a metal molded article manufacturing method.

### 2. Related Art

A metal molded article manufacturing method of manufacturing a metal molded article having a plurality of openings using an electroforming technique is known (for example, see JP1996-142334A (JP-H08-142334A)). The metal molded article manufacturing method described in JP1996-142334A (JP-H08-142334A) includes an electroforming step of growing a metal layer on a conductive surface by using an electroforming plate in which a non-conductive mask is formed on a part of a substrate having a conductive surface and immersing the electroforming plate in an electroforming liquid, and forming an opening at a position corresponding to the mask, and a metal molded article having an opening is manufactured by executing the electroforming step.

In JP1996-142334A (JP-H08-142334A) and JP2008-23792A, a nozzle plate used for a recording head of an inkjet printer is manufactured as a metal molded article. The nozzle ejects ink to record dots corresponding to pixels that are constituent elements of an image to be printed.

The nozzle plate is a thin metal plate in which a plurality of openings functioning as nozzles for ejecting ink are one-dimensionally or two-dimensionally arranged. In order to form a plurality of openings arranged in this way, in JP1996-142334A (JP-H08-142334A), JP2008-23792A, and the like, an electroforming plate in which a plurality of masks are one-dimensionally or two-dimensionally arranged on the surface of the conductive substrate is used.

### SUMMARY

In JP1996-142334A (JP-H08-142334A), JP2008-23792A, and the like, a photosensitive resin is used as a mask, and in a case where electroforming is performed using an electroforming plate to manufacture a metal molded article, and then the metal molded article is peeled off from the electroforming plate, both the mask and the electroforming plate are peeled off. Therefore, the electroforming plate comprising the mask could not be used a plurality of times.

In a case where the electroforming plate can be used a plurality of times, it is possible to improve the efficiency of the manufacturing process of the metal molded article and to suppress the cost.

The present disclosure has been made in view of the above circumstances, and an object of the present disclosure is to provide an electroforming plate for manufacturing a metal molded article having an opening according to a disposition of a mask by electroforming, the electroforming plate being capable of being used a plurality of times.

In addition, another object of the present disclosure is to provide a method of manufacturing an electroforming plate that can be used a plurality of times and a metal molded article manufacturing method using the electroforming plate.

An electroforming plate of the present disclosure comprises:
a semiconductor substrate; and
an insulating mask provided at a part of a surface of the semiconductor substrate, in which
the insulating mask is composed of an insulating layer formed by an insulating treatment on the surface of the semiconductor substrate,
at the surface of the semiconductor substrate, a portion where the insulating mask is not provided is an alloy layer containing a constituent element of the semiconductor substrate and a metal element diffused into the semiconductor substrate, and
the insulating mask protrudes from a surface of the alloy layer.

It is preferable that the insulating layer is an oxide film which is an oxide of a constituent element of the semiconductor substrate, a nitride film which is a nitride of the constituent element, or an oxynitride film which is an oxynitride of the constituent element.

It is preferable that the alloy layer is a thermal diffusion alloy layer in which the metal element is thermally diffused into the semiconductor substrate.

It is preferable that the semiconductor substrate is a silicon substrate, the insulating layer is a silicon oxide film, and the alloy layer contains silicon and the metal element as a main component.

It is preferable that the metal element is nickel, tantalum, or chromium.

A method of manufacturing an electroforming plate of the present disclosure includes:
a step of forming a resist pattern on an insulating layer of a semiconductor substrate, the insulating layer being formed by an insulating treatment on a surface of the semiconductor substrate;
a step of forming an insulating mask consisting of the insulating layer by etching the insulating layer using the resist pattern as an etching mask;
a step of forming a metal layer at the surface of the semiconductor substrate provided with the insulating mask;
a step of subjecting the semiconductor substrate provided with the metal layer to a heat treatment to diffuse a metal element constituting the metal layer from the surface of the semiconductor substrate into the semiconductor substrate; and
a step of removing the metal layer remaining at the surface of the semiconductor substrate.

It is preferable that in the step of forming the metal layer, a natural oxide film formed on the surface of the semiconductor substrate is removed, before forming the metal layer, in a film forming apparatus for forming the metal layer.

It is preferable that in the step of forming the metal layer, the metal layer is formed by using a sputtering method, and the removal of the natural oxide film is performed by reverse-sputtering the surface of the semiconductor substrate.

It is preferable that a silicon substrate is used as the semiconductor substrate.

A metal molded article manufacturing method using the electroforming plate of the present disclosure uses one sheet of the electroforming plate to manufacture a plurality of the metal molded article by repeating:
an electroforming step of energizing the alloy layer in a state where the electroforming plate is immersed in an electroforming liquid, growing a metal layer on a surface of the alloy layer by a metal precipitated from the electroforming liquid, and forming an opening at a position corresponding to the insulating mask to form a metal molded article having the opening;
a peeling step of peeling the metal molded article from the surface of the alloy layer; and
a washing step of washing the electroforming plate using sulfuric acid peroxide, sulfamic acid, or ferric chloride after the peeling step.

According to the present disclosure, it is possible to provide an electroforming plate for manufacturing a metal molded article having an opening according to a disposition of a mask by electroforming, the electroforming plate being capable of being used a plurality of times.

In addition, according to the present disclosure, it is possible to provide a method of manufacturing an electroforming plate that can be used a plurality of times and a metal molded article manufacturing method using the electroforming plate.

### BRIEF DESCRIPTION OF THE DRAWINGS

FIG. 1 is a perspective view showing an example of a metal molded article.

FIG. 2 is a plan view showing an electroforming plate.

FIG. 3 is a cross-sectional view of a part of the electroforming plate.

FIG. 4 is a view showing a manufacturing step of the electroforming plate.

FIG. 5 is a view showing a part of the manufacturing step of the electroforming plate.

FIG. 6 is a view showing a manufacturing step of the metal molded article.

### DESCRIPTION OF EMBODIMENTS

Hereinafter, embodiments of the present disclosure will be described with reference to the drawings.

### Metal Molded Article

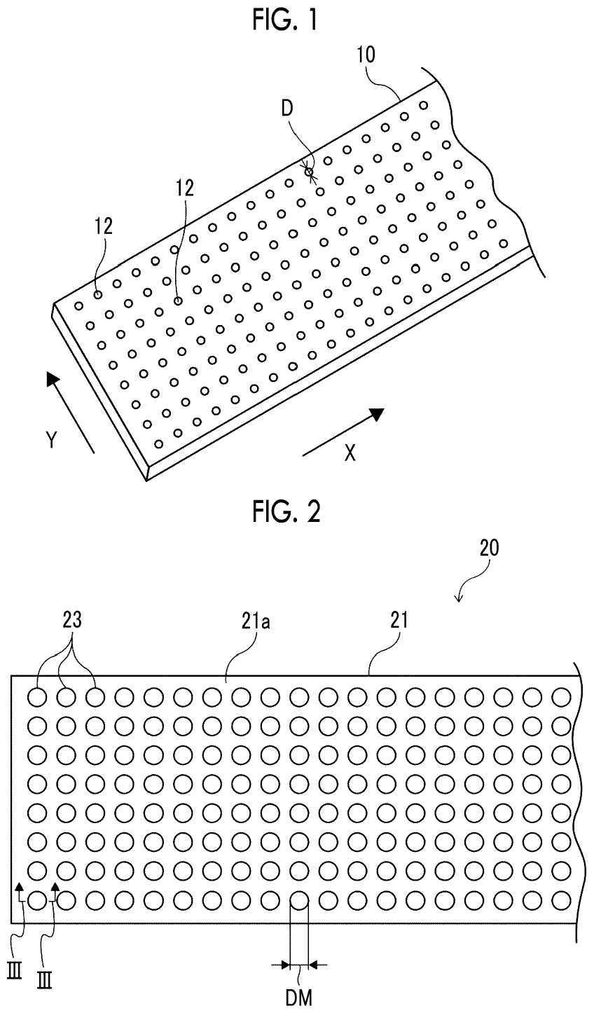

FIG. 1 is a view showing an example of a metal molded article having an opening, which is produced by a metal molded article manufacturing method of an embodiment using an electroforming plate of the embodiment. In the present example, the metal molded article is a nozzle plate 10 used for a recording head of an inkjet printer.

The nozzle plate 10 is a plate-shaped member having a rectangular planar shape which is formed of an electroforming metal such as nickel (Ni). In the nozzle plate 10, a plurality of substantially circular openings 12 (hereinafter, referred to as nozzles 12) that function as nozzles are formed by being two-dimensionally arranged. The nozzle 12 is formed in a substantially circular shape, and a diameter D thereof is, for example, 100 μm or less, and preferably 20 μm to 50 μm. In the recording head, the nozzle plate 10 is disposed in a posture in which a longitudinal direction corresponds to a main scanning direction X of the inkjet printer and a lateral direction corresponds to a sub-scanning direction Y. A length of the nozzle plate 10 in the main scanning direction is, for example, 100 mm, and a length of the nozzle plate 10 in the sub-scanning direction is, for example, 40 mm. Further, in the present example, eight nozzle rows including 130 nozzles 12 arranged at regular intervals in the main scanning direction X of the nozzle plate 10 are provided in the sub-scanning direction Y.

### Electroforming Plate

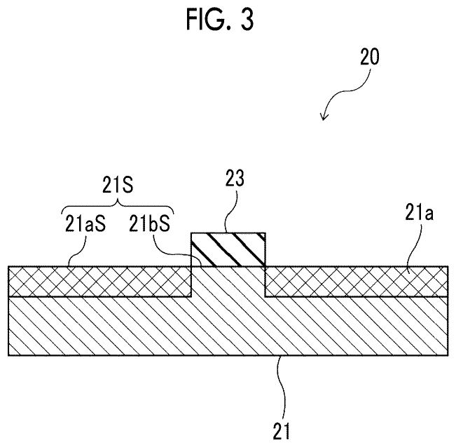

FIG. 2 is a plan view showing a part of the electroforming plate 20 of the embodiment used for manufacturing the nozzle plate 10, and FIG. 3 is a cross-sectional view of a portion of the electroforming plate 20 shown in FIG. 2 taken along line III-III.

The electroforming plate 20 comprises a semiconductor substrate 21 and an insulating mask 23 (hereinafter, referred to as mask 23) provided on a part of a surface 21S of the semiconductor substrate 21. The mask 23 is provided in order to form an opening (here, the nozzle 12 of the nozzle plate 10) of a metal molded article. On the surface of the semiconductor substrate 21, a portion where the mask 23 is not provided is an alloy layer 21a containing a constituent element of the semiconductor substrate 21 and a metal element. The alloy layer 21a has conductivity, and in a case of electroforming using the electroforming plate 20, a metal layer, which is the nozzle plate 10, grows on the surface of the alloy layer 21a.

The mask 23 is formed at a portion corresponding to a nozzle forming position in order to form the nozzle 12 provided in the nozzle plate 10. In the present example, the mask 23 is circular. Since the mask 23 has insulating properties, the metal does not grow in the portion of the mask 23 and an opening is formed, and the nozzle 12 is formed. In the present example, 130×8 masks 23 are formed in a region of 100 mm×40 mm of the electroforming plate 20 corresponding to the arrangement pitch and the number of the nozzles 12 of the nozzle plate 10 described above. A diameter DM of the mask 23 is greater than the diameter D of the nozzle 12, and is, for example, 150 μm to 200 μm. A thickness of the mask 23 is, for example, 2 μm.

The mask 23 is composed of an insulating layer formed by an insulating treatment on the surface of the semiconductor substrate 21. The insulating treatment on the surface of the semiconductor substrate 21 is a treatment of diffusing an element that forms an insulating body by being bonded to a semiconductor constituent element, such as oxygen, nitrogen, or a combination of oxygen and nitrogen, to the surface of the semiconductor substrate 21, and specific examples thereof include a thermal diffusion treatment and an ion implantation treatment using ion beam mixing. In a case of the thermal diffusion treatment, for example, the semiconductor substrate 21 is subjected to a heat treatment in a gas containing oxygen, a gas containing nitrogen, or a gas containing oxygen and nitrogen, and oxygen, nitrogen, or a combination of oxygen and nitrogen is thermally diffused into the surface layer of the semiconductor substrate 21. In a case of the ion implantation treatment, for example, oxygen ion, nitrogen ion, or a combination of oxygen ion and nitrogen ion are implanted as ion beam onto the surface of the semiconductor substrate 21 and diffused into the surface layer of the semiconductor substrate 21. By such treatments, the semiconductor element constituting the semiconductor substrate 21 is oxidized, nitrided, or oxynitrided in the surface layer of the semiconductor substrate 21, and an oxide, a nitride, or an oxynitride of the semiconductor element is formed and is insulated. That is, the insulating layer formed by the insulating treatment on the surface of the semiconductor substrate 21 is an insulated region in the surface layer of the semiconductor substrate 21 by the insulating treatment. The insulating layer formed by the insulating treatment is preferably the oxide, the nitride, or the oxynitride of the constituent element of the semiconductor substrate 21. The insulating layer formed by the insulating treatment is preferably consisting of a thermal oxide film which is the oxide of the constituent element of the semiconductor substrate 21, a thermal nitride film which is the nitride of the constituent element of the semiconductor substrate 21, or a thermal oxynitride film which is the oxynitride of the constituent element of the semiconductor substrate 21, which are formed by the thermal diffusion treatment.

As described above, the mask 23 in the electroforming plate 20 forms an insulating region formed on the surface layer of the semiconductor substrate 21 by atomic diffusion on the surface of the semiconductor substrate 21, and consists of an insulating layer formed by patterning. The mask 23 is obtained by patterning the insulating layer (that is, the insulating region of the surface layer of the semiconductor substrate 21) formed by the atomic diffusion on the surface of the semiconductor substrate 21. That is, in the present embodiment, the mask 23 is not formed of an insulating layer formed on the surface of the semiconductor substrate 21 by chemical vapor deposition, physical vapor deposition, or the like.

However, the expression “the mask is composed of an insulating layer (hereinafter, first insulating layer) formed by an insulating treatment on the surface of the semiconductor substrate” in the present specification does not mean that the mask is limited to a mask composed only of the first insulating layer, but means that the mask is mainly composed of the first insulating layer. The term “mainly” means that the first insulating layer occupies at least 80% or more of the thickness of the mask 23 in a direction perpendicular to the surface of the semiconductor substrate 21 from the semiconductor substrate 21 side. Therefore, the mask 23 may have a laminated structure comprising a second insulating layer having favorable adhesiveness to the first insulating layer on the first insulating layer. Specifically, the mask 23 may comprise an insulating layer (hereinafter, a second insulating layer) formed on the first insulating layer (for example, a thermal oxide film) further formed by the insulating treatment on the surface of the semiconductor substrate 21 by vapor deposition or the like. In this case, from the viewpoint of adhesiveness, it is preferable that the first insulating layer and the second insulating layer consist of the same constituent element.

Examples of the semiconductor substrate 21 include a silicon (Si) substrate, a germanium (Ge) substrate, and the like, and the silicon substrate is particularly preferable. The semiconductor substrate 21 may be n-type or p-type, or may be an intrinsic semiconductor not containing impurities. In a case where the semiconductor substrate 21 is the silicon substrate, the constituent element is silicon, and the oxide, the nitride, and the oxynitride of the constituent element are a silicon oxide, a silicon nitride, and a silicon oxynitride, respectively. The alloy layer 21a is a layer in which the metal element is diffused into the surface layer of the semiconductor substrate 21, and includes the constituent element of the semiconductor substrate 21 and the metal element diffused into the semiconductor substrate 21. In the alloy layer 21a, the proportion occupied by the constituent element and the metal element of the semiconductor substrate 21 in all the elements constituting the alloy layer 21a is desirably 80 at % or more, and more preferably 90 at % or more. As shown in FIG. 3, the surface layer of the semiconductor substrate 21 has a region where the alloy layer 21a is formed and a region where the alloy layer 21a is not formed. The surface 21S of the semiconductor substrate 21 is a substantially flat surface, and is composed of an alloy layer surface 21aS and a semiconductor surface 21bS. The alloy layer surface 21aS is a surface of the region where the alloy layer 21a is formed, and the semiconductor surface 21bS is a surface of the region where the alloy layer 21a is not formed. Since the mask 23 is formed on the flat surface 21S of the semiconductor substrate 21, the mask 23 protrudes from the surface of the alloy layer 21a. A portion in contact with the mask 23 of the semiconductor substrate 21 includes a region where the alloy layer 21a is not formed. Basically, a portion in contact with the mask 23 coincides with the semiconductor surface 21bS on which the alloy layer 21a is not formed, but a part of the alloy region may be included inside the peripheral edge of the mask 23.

The alloy layer 21a is a region that has been alloyed by diffusing a metal element into the surface layer of the semiconductor substrate 21, and is not a film formed on the semiconductor substrate 21. In a case where the semiconductor substrate 21 is the silicon substrate, the alloy layer 21a contains silicon and a metal element as main components. Here, “containing silicon and a metal element as main components” means that a proportion occupied by silicon and a metal element in all the elements constituting the alloy layer 21a is 80 at % or more.

The alloy layer 21a can be formed, for example, by forming a metal layer on the semiconductor surface of the semiconductor substrate 21 and then performing a heat treatment to diffuse a metal element from the metal layer into the surface layer of the semiconductor substrate 21 (see the method of manufacturing the electroforming plate described later). In addition, the alloy layer 21a can also be formed by implanting metal ion onto the semiconductor surface of the semiconductor substrate 21 as ion beam and diffusing the metal ion into the surface layer of the semiconductor substrate 21. The alloy layer 21a is particularly preferably a thermal diffusion alloy layer.

Examples of the metal to be alloyed with the constituent element constituting the semiconductor substrate 21 include nickel (Ni), tantalum (Ta) and chromium (Cr), cobalt (Co), molybdenum (Mo), palladium (Pd), tungsten (W), platinum (Pt), titanium (Ti), vanadium (V), niobium (Nb), hafnium (Hf), zirconium (Zr), and alloys thereof, and nickel is particularly preferable. In a case where the semiconductor substrate 21 is a silicon substrate and the metal for alloying is nickel, the alloy layer 21a is nickel silicide.

In the electroforming plate 20 described above, since the mask 23 consists of an insulating layer formed by the insulating treatment on the surface of the semiconductor substrate 21, the mask 23 has high adhesiveness to the semiconductor substrate 21, and the mask 23 is not peeled off from the semiconductor substrate in a case where the metal molded article, which is an electroformed article, is peeled off. Therefore, in a case where a plurality of metal molded articles are manufactured, it is not necessary to form the mask 23 again. Since the mask 23 protrudes from the alloy layer surface 21 aS of the alloy layer 21a, the mask 23 has high functionality as a mask that forms an opening in the metal molded article such as the nozzle 12 of the nozzle plate 10. It is possible to suppress the variation in the opening diameter without performing a step of forming a mask made of a resist film on the thermal oxide film as in JP1996-142334A (JP-H08-142334A).

Since the alloy layer 21a is an alloy layer containing, as main components, a constituent element of the semiconductor substrate 21 and a metal element, in which the metal element is diffused into the surface layer of the semiconductor substrate 21, the alloy layer 21a remains as a part of the semiconductor substrate 21 without being peeled off together with the metal molded article in a case where the metal molded article, which is an electroformed article, is peeled off. Therefore, as well as it is possible to use the electroforming plate 20 a plurality of times without forming the alloy layer 21a again, it is not necessary to form the mask 23 on the semiconductor substrate 21 again. Therefore, the efficiency of the manufacturing process of the metal molded article can be improved, and the manufacturing cost can be suppressed.

In addition, even in a case where the mask 23 has a laminated structure comprising an insulating layer (first insulating layer) formed by the insulating treatment on the surface of the semiconductor substrate 21 and an insulating layer (second insulating layer) further formed on the insulating layer by vapor deposition or the like, in a case where the adhesiveness of the second insulating layer to the first insulating layer is favorable, the mask 23 remains on the electroforming plate 20 side even in a case where the metal molded article is peeled off, and the same effects as described above can be obtained. In a case where the thickness of the first insulating layer is 80% or more of the thickness of the mask 23, the adhesiveness between the first insulating layer and the second insulating layer can be improved. In addition, in a case where the thickness of the first insulating layer is 80% or more of the thickness of the mask 23, even though the second insulating layer is peeled off from the first insulating layer (that is, from the electroforming plate), the first insulating layer ensures the function as the mask 23, and the electroforming plate 20 can be repeatedly used without forming the mask 23 again.

However, in a case where the second insulating layer is provided, since a material and a step for forming the second insulating layer are required, it is more preferable that the mask 23 is composed only of the insulating layer formed by the insulating treatment on the surface of the semiconductor substrate 21 from the viewpoint of suppressing the manufacturing cost of the electroforming plate and improving the efficiency of the manufacturing process.

In addition, since the semiconductor substrate 21 is used as a main body of the electroforming plate 20, the electroforming plate 20 has high resistance to a chemical liquid for dissolving the electroforming residue, which is performed before the next metal molded article is produced after the manufacturing of one metal molded article, in a case where the manufacturing of the metal molded article, which will be described later, is repeatedly performed.

### Method of Manufacturing Electroforming Plate

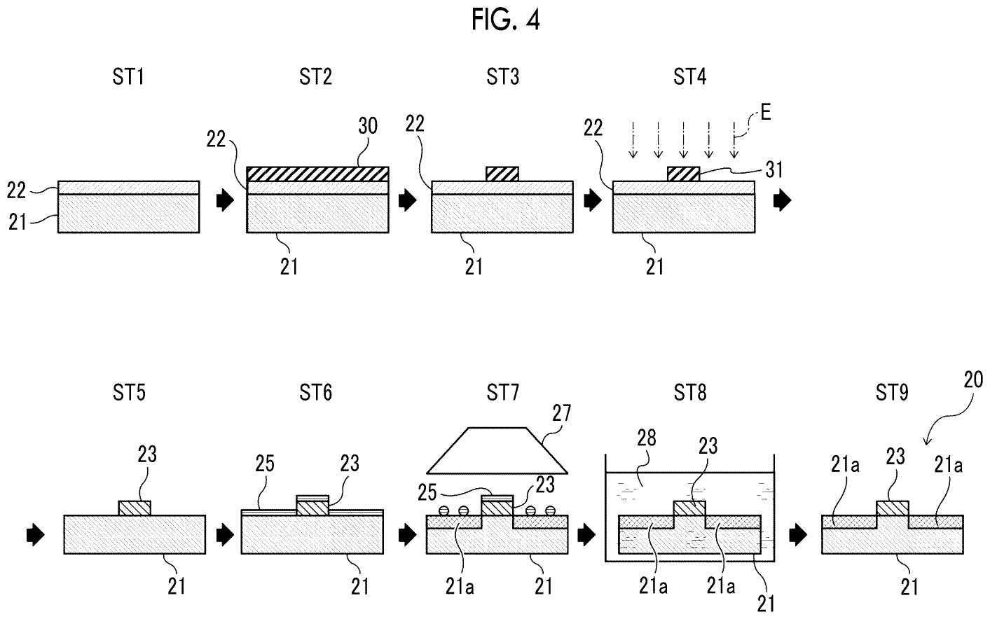

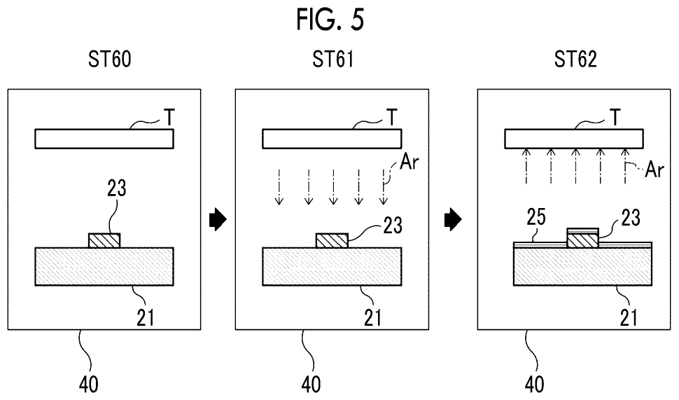

As the embodiment of the method of manufacturing the electroforming plate according to the present disclosure, the method of manufacturing the electroforming plate 20 will be described with reference to FIGS. 4 and 5. FIG. 4 shows a manufacturing step, and FIG. 5 shows a preferred step example of one step shown in FIG. 4.

First, in the step ST1, the semiconductor substrate 21 having an insulating layer 22 formed by the insulating treatment on the surface is prepared. For example, the insulating layer 22 can be formed on the surface of the semiconductor substrate 21 by diffusing oxygen into the surface layer of the semiconductor substrate 21 by performing the heat treatment on the semiconductor substrate 21 in a gas containing oxygen. A commercially available thermal oxide film silicon wafer may be prepared.

Next, in the step ST2, a resist film 30 is formed on the insulating layer 22 of the semiconductor substrate 21 having the insulating layer 22, and exposure is performed using a pattern forming mask (not shown) to form a resist pattern 31 as shown in the step ST3. As described above, the steps ST2 and ST3 are steps of forming the resist pattern 31 on the insulating layer 22 of the semiconductor substrate 21 having the insulating layer 22.

As shown in the step ST4, the insulating layer 22 is etched using the resist pattern 31 as an etching mask to form the mask 23 consisting of the insulating layer 22 as shown in the step ST5. In the step ST4, the arrow E schematically indicates an etching gas during dry etching.

Next, in the step ST6, the metal layer 25 is formed on the surface of the semiconductor substrate 21 comprising the mask 23. A method of forming the metal layer 25 is not particularly limited, but it is preferable to form by a sputtering method. The film thickness of the metal layer 25 is preferably 5 nm or more and 200 nm or less, and more preferably 10 nm or more and 100 nm or less.

Then, in the step ST7, the semiconductor substrate 21 comprising the metal layer 25 is subjected to the heat treatment to diffuse the metal element constituting the metal layer 25 from the surface of the semiconductor substrate 21 to the semiconductor substrate 21. That is, the thermal diffusion treatment of heating the semiconductor substrate 21 with the heating device 27 to thermally diffuse the metal element into the semiconductor substrate 21 is performed. As a result, the metal element is diffused into the surface layer of the semiconductor substrate 21, and the surface layer of the semiconductor substrate 21 is alloyed to form the alloy layer 21a. The alloy layer 21a is formed directly below a portion in which the metal layer 25 is formed in contact with the semiconductor substrate 21. Although the metal element is hardly formed directly below the mask 23, some metal elements may be diffused directly below the vicinity of the peripheral edge of the mask 23. In addition, the metal element of the metal layer 25 on the mask 23 is hardly diffused into the mask 23, and the metal layer 25 on the mask 23 is maintained even after heating. Examples of the heating device 27 include a hot plate, a rapid thermal processing apparatus (RTA), and the like. In addition, the heating atmosphere is preferably a vacuum or an inert gas atmosphere such as nitrogen or argon so that the metal layer is not oxidized. The conditions such as the heating temperature and time may be appropriately selected depending on the metal element to be used. For example, in a case where nickel is used as the metal layer and silicon is used as the semiconductor substrate, the heating temperature with a vacuum hot plate (PH222 custom manufactured by MSA Factory) is preferably 200° C. or higher and 700° C. or lower, and more preferably 250° C. or higher and 400° C. or lower. The heating time is preferably 1 minute or longer and 60 minutes or shorter, and more preferably 5 minutes or longer and 20 minutes or shorter.

After the thermal diffusion treatment, in the step ST8, the metal layer 25 remaining on the surface of the semiconductor substrate 21 is removed. Specifically, by washing with a sulfuric acid hydrogen peroxide mixed solution (for example, SH-303 manufactured by Kanto Chemical Co., Inc.) 28, the metal layer 25 remaining on the surface without diffusing into the semiconductor substrate 21 is removed among the metal layer 25 formed on the mask 23 of the semiconductor substrate 21 and the metal layer 25 formed on a portion other than the mask 23. Although an oxide of a metal element, a semiconductor substrate element, or the like may be formed on the surface after washing, there is no problem as long as the electroforming step is not affected.

As described above, the electroforming plate 20 can be produced on the surface of the semiconductor substrate 21 shown in the step ST9.

FIG. 5 shows a preferred aspect of the step of forming the metal layer 25 in the step ST6. In a semiconductor substrate 21 such as a silicon substrate, the surface may be oxidized in the atmosphere to form a natural oxide film. In a case where the natural oxide film is formed after the formation of the metal layer 25, the natural oxide film serves as a barrier even after the thermal diffusion treatment is performed. As a result, the metal element is not diffused into the semiconductor substrate 21, and the alloy layer 21a cannot be formed. Therefore, in a case where a natural oxide film is formed on the surface of the semiconductor substrate 21, it is preferable to remove the natural oxide film formed on the surface of the semiconductor substrate 21 before forming the metal layer 25 on the surface of the semiconductor substrate 21. Examples of the method of removing the natural oxide film include a method of cleaning the substrate by irradiating the substrate with ion beam and reverse sputtering.

As a specific procedure, a case of forming the metal layer 25 using a sputtering method will be described.

As shown in the step ST60 of FIG. 5, the semiconductor substrate 21 comprising the mask 23 is set in the sputter film forming apparatus 40 comprising a target T for forming the metal layer 25.

Then, as shown in the step ST61, the natural oxide film is removed by reverse-sputtering the surface of the semiconductor substrate 21 before the metal layer 25 is formed. In the step ST61, the direction of the arrow indicates the traveling direction of the sputter ion Ar.

After removing the natural oxide film, the target T is sputtered to form the metal layer 25 as in the step ST62.

In this way, in the sputter film forming apparatus 40, after removing the natural oxide film, the metal layer 25 is formed without exposing the semiconductor substrate 21 to the atmosphere. As a result, in the subsequent thermal diffusion step, the metal element can be reliably diffused into the semiconductor substrate 21.

### Metal Molded Article Manufacturing Method

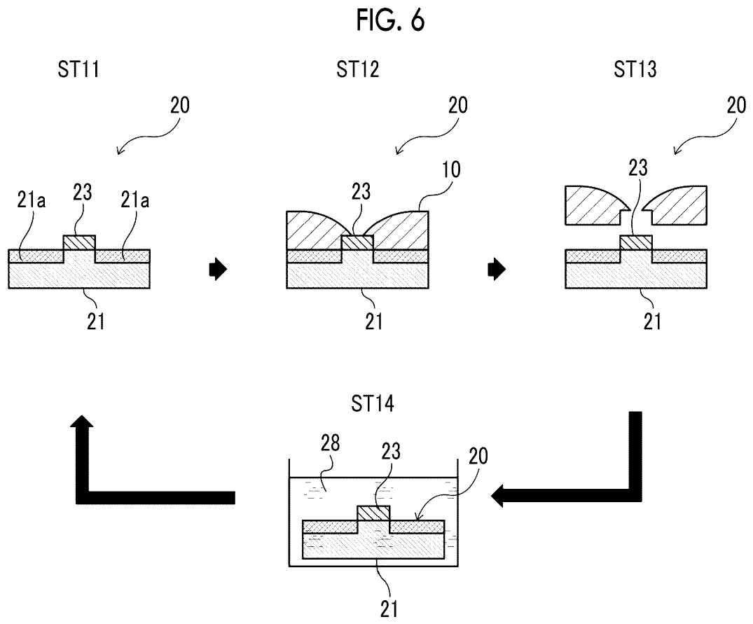

The embodiment of the metal molded article manufacturing method of the present disclosure using the electroforming plate 20 will be described with reference to FIG. 6. FIG. 6 shows a manufacturing step of the nozzle plate 10 as a metal molded article.

The alloy layer 21a is energized in a state where the electroforming plate 20 is immersed in the electroforming liquid, and a metal layer is grown on the surface of the alloy layer 21a by the metal precipitated from the electroforming liquid (electroforming steps ST11 and ST12).

The electroforming steps ST11 and ST12 are performed in a state where the electroforming plate 20 is immersed in the electroforming liquid accommodated in an electroforming tank (not shown) by a holding mechanism (not shown).

In the electroforming step ST11, the metal layer 11 grows on the surface of the alloy layer 21a, but the metal is not precipitated on the surface of the insulating mask 23, and the metal layer 11 does not grow. The metal layer 11 gradually grows on the surface of the alloy layer 21a. Thereafter, in a case where the thickness of the grown metal layer 11 exceeds the thickness of the mask 23, the metal layer 11 grows from the surface of the metal layer 11 that has grown earlier to cover the edge portion of the mask 23 on the mask 23 side. As the metal layer 11 grows from the edge portion of the mask 23 toward the center, an opening is formed in the metal layer 11 with the opening center at a substantially center position of the mask 23. The opening is the nozzle 12. As the thickness of the metal layer 11 increases, the metal layer 11 grows toward the center of the mask 23. Therefore, the opening diameter of the nozzle 12 also gradually decreases. The diameter of the mask 23 is determined such that the nozzle 12 has a desired opening diameter in a case where the metal layer 11 is grown to have a desired thickness. The growth of the metal layer 11 on the mask 23 is larger at a position closer to the surface of the alloy layer 21a. Therefore, as shown in the step ST12 of FIG. 6, the opening diameter of the nozzle 12 is smaller as it is closer to the surface of the alloy layer 21a and larger as it is farther from the surface of the alloy layer 21a, and the cross section of the metal layer 11 constituting the inner wall surface of the nozzle 12 is arc-shaped. For example, as a reference for the target opening diameter of the nozzle 12, the opening diameter of the nozzle 12 on the position closer to the surface of the alloy layer 21a is set. Then, the diameter of the mask 23 is determined such that the opening diameter of the reference nozzle 12 is the target opening diameter. The thickness of the metal layer 11 is, for example, about 50 μm.

Next, the nozzle plate 10 consisting of the metal layer 11 deposited by electroforming is peeled off from the surface of the alloy layer 21a, that is, from the electroforming plate 20 (peeling step ST13). In this case, the mask 23 remains on the semiconductor substrate 21 without being peeled off from the semiconductor substrate 21. In this manner, the nozzle plate 10 can be manufactured by electroforming using the electroforming plate 20.

After the peeling step ST13, the electroforming plate 20 from which the nozzle plate 10 is peeled off is washed with the sulfuric acid hydrogen peroxide mixed solution 28 (washing step ST14). As the washing solution, sulfamic acid or ferric chloride may be used instead of the sulfuric acid hydrogen peroxide mixed solution. The electroforming plate 20 after the peeling step returns to the electroforming plate 20 before electroforming by the washing step ST14.

By repeating the electroforming steps ST11 and ST12, the peeling step ST13, and the washing step ST14, a plurality of nozzle plates 10, which are metal molded articles, can be manufactured using one sheet of electroforming plate 20.

The electroforming plate 20 comprises the semiconductor substrate 21, and the mask 23 provided by insulating and further patterning a part of the semiconductor substrate 21, and further comprises the alloy layer 21a formed by alloying the surface of the semiconductor substrate 21. According to this configuration, the mask 23 and the alloy layer 21a are not peeled off during peeling of the metal molded article after electroforming. In the washing step ST14, only the electroforming residue and the attachment remaining on the surface of the electroforming plate 20 after the peeling can be removed without the electroforming plate 20 being eroded by the washing solution such as the sulfuric acid hydrogen peroxide mixed solution 28. Thereafter, a plurality of metal molded articles can be manufactured by repeatedly using the electroforming plate 20 without performing a treatment such as reforming the mask 23 or imparting conductivity to the mask 23.

In regard to the embodiment described above, the following supplementary notes will be further disclosed.

### Supplementary Note 1

An electroforming plate comprising:
a semiconductor substrate; and
an insulating mask provided at a part of a surface of the semiconductor substrate, in which
the insulating mask is composed of an insulating layer formed by an insulating treatment on the surface of the semiconductor substrate,
at the surface of the semiconductor substrate, a portion where the insulating mask is not provided is an alloy layer containing a constituent element of the semiconductor substrate and a metal element diffused into the semiconductor substrate, and
the insulating mask protrudes from a surface of the alloy layer.

### Supplementary Note 2

The electroforming plate according to Supplementary Note 1, in which the insulating mask consists of an oxide film which is an oxide of a constituent element of the semiconductor substrate.

### Supplementary Note 3

The electroforming plate according to Supplementary Note 1 or 2, in which the alloy layer is a thermal diffusion alloy layer in which the metal element is thermally diffused into the semiconductor substrate.

### Supplementary Note 4

The electroforming plate according to any one of Supplementary Notes 1 to 3, in which the semiconductor substrate is a silicon substrate, the insulating layer is a silicon oxide film, and the alloy layer contains silicon and the metal element as a main component.

### Supplementary Note 5

The electroforming plate according to Supplementary Note 4, in which the metal element is nickel, tantalum, or chromium.

### Supplementary Note 6

A method of manufacturing an electroforming plate, the method including:
a step of forming a resist pattern on an insulating layer of a semiconductor substrate, the insulating layer being formed by an insulating treatment on a surface of the semiconductor substrate;
a step of forming an insulating mask consisting of the insulating layer by etching the insulating layer using the resist pattern as an etching mask;
a step of forming a metal layer at the surface of the semiconductor substrate provided with the insulating mask;
a step of subjecting the semiconductor substrate provided with the metal layer to a heat treatment to diffuse a metal element constituting the metal layer from the surface of the semiconductor substrate into the semiconductor substrate; and
a step of removing the metal layer remaining at the surface of the semiconductor substrate.

### Supplementary Note 7

The method of manufacturing an electroforming plate according to Supplementary Note 6, in which
in the step of forming the metal layer, a natural oxide film formed on the surface of the semiconductor substrate is removed, before forming the metal layer, in a film forming apparatus for forming the metal layer.

### Supplementary Note 8

The method of manufacturing an electroforming plate according to Supplementary Note 7, in which in the step of forming the metal layer, the metal layer is formed by using a sputtering method, and the removal of the natural oxide film is performed by reverse-sputtering the surface of the semiconductor substrate.

### Supplementary Note 9

The method of manufacturing an electroforming plate according to any one of Supplementary Notes 6 to 8, in which a silicon substrate is used as the semiconductor substrate.

### Supplementary Note 10

A metal molded article manufacturing method using the electroforming plate according to any one of Supplementary Notes 1 to 5, in which one sheet of the electroforming plate is used to manufacture a plurality of the metal molded article by repeating:
an electroforming step of energizing the alloy layer in a state where the electroforming plate is immersed in an electroforming liquid, growing a metal layer on a surface of the alloy layer by a metal precipitated from the electroforming liquid, and forming an opening at a position corresponding to the insulating mask to form a metal molded article having the opening;
a peeling step of peeling the metal molded article from the surface of the alloy layer; and
a washing step of washing the electroforming plate using sulfuric acid peroxide, sulfamic acid, or ferric chloride after the peeling step.

What is claimed is:

1. An electroforming plate comprising:
a semiconductor substrate; and
an insulating mask provided at a part of a surface of the semiconductor substrate, wherein:
the insulating mask is composed of an insulating layer formed by an insulating treatment on the surface of the semiconductor substrate,
at the surface of the semiconductor substrate, a portion where the insulating mask is not provided is an alloy layer containing a constituent element of the semiconductor substrate and a metal element diffused into the semiconductor substrate, and
the insulating mask protrudes from a surface of the alloy layer.

2. The electroforming plate according to claim 1, wherein
the insulating layer is an oxide film which is an oxide of a constituent element of the semiconductor substrate, a nitride film which is a nitride of the constituent element, or an oxynitride film which is an oxynitride of the constituent element.

3. The electroforming plate according to claim 1, wherein
the alloy layer is a thermal diffusion alloy layer in which the metal element is thermally diffused into the semiconductor substrate.

4. The electroforming plate according to claim 1, wherein
the semiconductor substrate is a silicon substrate, the insulating layer is a silicon oxide film, and the alloy layer contains silicon and the metal element as a main component.

5. The electroforming plate according to claim 4, wherein
the metal element is nickel, tantalum, or chromium.

6. A method of manufacturing an electroforming plate, the method comprising:
a step of forming a resist pattern on an insulating layer of a semiconductor substrate, the insulating layer being formed by an insulating treatment on a surface of the semiconductor substrate;
a step of forming an insulating mask consisting of the insulating layer by etching the insulating layer using the resist pattern as an etching mask;
a step of forming a metal layer at the surface of the semiconductor substrate provided with the insulating mask;
a step of subjecting the semiconductor substrate provided with the metal layer to a heat treatment to diffuse a metal element constituting the metal layer from the surface of the semiconductor substrate into the semiconductor substrate; and
a step of removing the metal layer remaining at the surface of the semiconductor substrate.

7. The method of manufacturing an electroforming plate according to claim 6, wherein
in the step of forming the metal layer, a natural oxide film formed at the surface of the semiconductor substrate is removed, before forming the metal layer, in a film forming apparatus for forming the metal layer.

8. The method of manufacturing an electroforming plate according to claim 7, wherein
in the step of forming the metal layer, the metal layer is formed by using a sputtering method, and the removal of the natural oxide film is performed by reverse-sputtering the surface of the semiconductor substrate.

9. The method of manufacturing an electroforming plate according to claim 6, wherein
a silicon substrate is used as the semiconductor substrate.

10. A metal molded article manufacturing method using the electroforming plate according to claim 1, in which one sheet of the electroforming plate is used to manufacture a plurality of the metal molded article by repeating:
an electroforming step of energizing the alloy layer in a state where the electroforming plate is immersed in an electroforming liquid, growing a metal layer on a surface of the alloy layer by a metal precipitated from the electroforming liquid, and forming an opening at a position corresponding to the insulating mask to form a metal molded article having the opening;
a peeling step of peeling the metal molded article from the surface of the alloy layer; and
a washing step of washing the electroforming plate using sulfuric acid peroxide, sulfamic acid, or ferric chloride after the peeling step.
